(19) United States
(12) Patent Application Publication
(10) Pub. No.: US 2006/0266424 A1
(43) Pub. Date: Nov. 30, 2006

(54) Water tap

(76) Inventor: Roger Filtness, Bristall (GB)

Correspondence Address: MADSON & AUSTIN;GATEWAY TOWER WEST, SUITE 900, 15 WEST SOUTH TEMPLE, SALT LAKE CITY, UT, 84101, US

(21) Appl. No.: 11/431,141

(22) Filed: May 9, 2006

(30) Foreign Application Priority Data
May 9, 2005 (GB) 0509348.9

(51) Int. Cl. F16K 11/078

(52) U.S. Cl. 137/625.4

(57) ABSTRACT

A water tap assembly having a tap body, separate connections on the tap body for receiving supplies of hot water H, cold water C and filtered water F, a common discharge spout mounted on the tap body, and valve means for controlling the supply of hot, cold, and filtered water from the tap body to the discharge spout. The discharge spout provides only two separate internal discharge passages which lead to a common discharge outlet. The tap body defines a route for hot water only communicating with a dedicated first discharge passage. The tap body also defines separate incoming routes for cold and filtered water, and a common outgoing route for cold and filtered water communicating with a dedicated second discharge passage. The valve means selectively diverts and controls the flow of incoming cold or filtered water with the common outgoing route. A spray unit is coupled with the tap body, and the assembly is operative to route rinsing water to the spray unit.

This invention relates to a water tap assembly having a tap body, separate connections on the tap body for receiving supplies of hot water, cold water and filtered water, a common discharge spout mounted on the tap body, and valves means for controlling the supply of hot water, cold water and filtered water from the tap body to the discharge spout.

### BACKGROUND TO THE INVENTION

It is well known to provide a common discharge spout, for discharging hot and/or cold water, and the spout may have two separate passages, each dedicated to one of the hot and cold water supplies, and which have discharge outlets located adjacent to, or close to each other, and so that a single jet of hot and/or cold water can be discharged. Alternatively, the spout may have a single passage, along which hot only, or cold only water may pass, upon opening of the hot or cold valves. In addition, the tap body may incorporate a pre-mixing chamber, in which hot and cold water supplies may be mixed (upon opening of both of the hot and cold water valves), prior to the mixed supply passing along the single passage in the discharge spout to be discharged as a mixed jet of hot and cold water.

It is also known to provide a discharge spout with three separate dedicated passages, corresponding to hot, cold, and filtered water supply, and this has the claimed advantage that there will be no “contamination” of the filtered water passage, in that it will always only convey filtered water. However, the fabrication costs of providing three separate routes for the three different water supplies through the tap body, and the provision of three separate discharge passages within the common discharge spout, make this an expensive item which is not suitable for the mass market which requires the facility to obtain occasional supply of filtered water (in addition to more regular usage of hot and/or cold water), but not at premium cost.

It is also known to provide a hand or side spray unit, for the purposes of rinsing a sink, and which is coupled to a water tap assembly. A spray head is mounted at one end of a flexible water pipe, and the other end of which is connected to the tap assembly. By operation of suitable controls on the tap assembly, the incoming supply of hot and/or cold water can be diverted to flow along the flexible water pipe to the spray head, instead of passing to the common discharge spout. This enables the user to thoroughly wash or rinse the sink, after dirty water has been discharged to the usual waste pipe connected to the sink. The flexibility of the pipe connected to the spray head enables the user to direct rinsing water (hot, cold or a mixture of hot and cold) to all areas of the sink which require rinsing down.

To date, it has not been possible to provide a hand operated spray unit in assembly with a water tap fitting which is designed so as to be able to discharge hot water, cold water, a mixture of hot and cold water, or filtered water to a common discharge spout.

The present invention has been developed with a view to address this need, and to provide a tap assembly including a common discharge spout connected to a tap body, and also a hand operated spray unit connected to the tap body, in which the assembly can be operated to discharge any selected one of: hot water, cold water, a mixture of hot and cold water, and filtered water, to the discharge spout, and also can be operated to discharge at least one of hot water, cold water, and a mixture of hot/cold water to the spray unit.

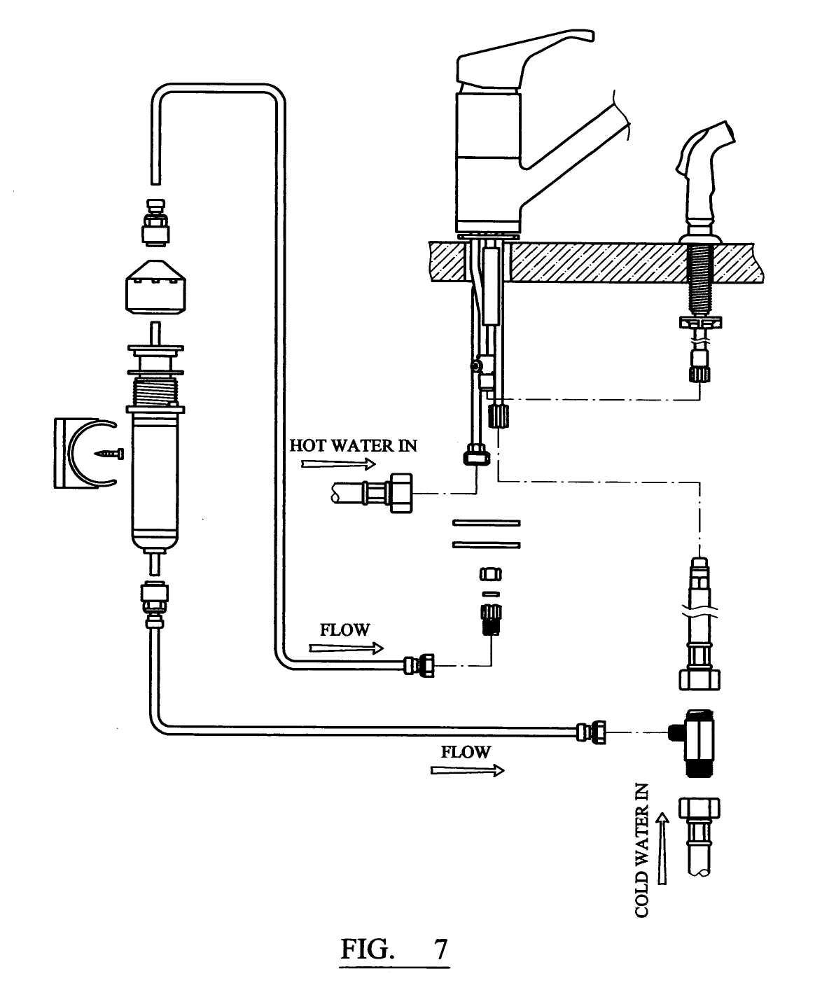

A preferred embodiment of the invention will be described, by way of example only, with reference to FIGS. 7 to 15 of the accompanying illustrations.

However, by way of background to the description of the preferred embodiment, reference will first be made to the following description of a water tap assembly which is disclosed in more detail in International publication number 2004/104306, and the disclosure of which is incorporated herein by this reference.

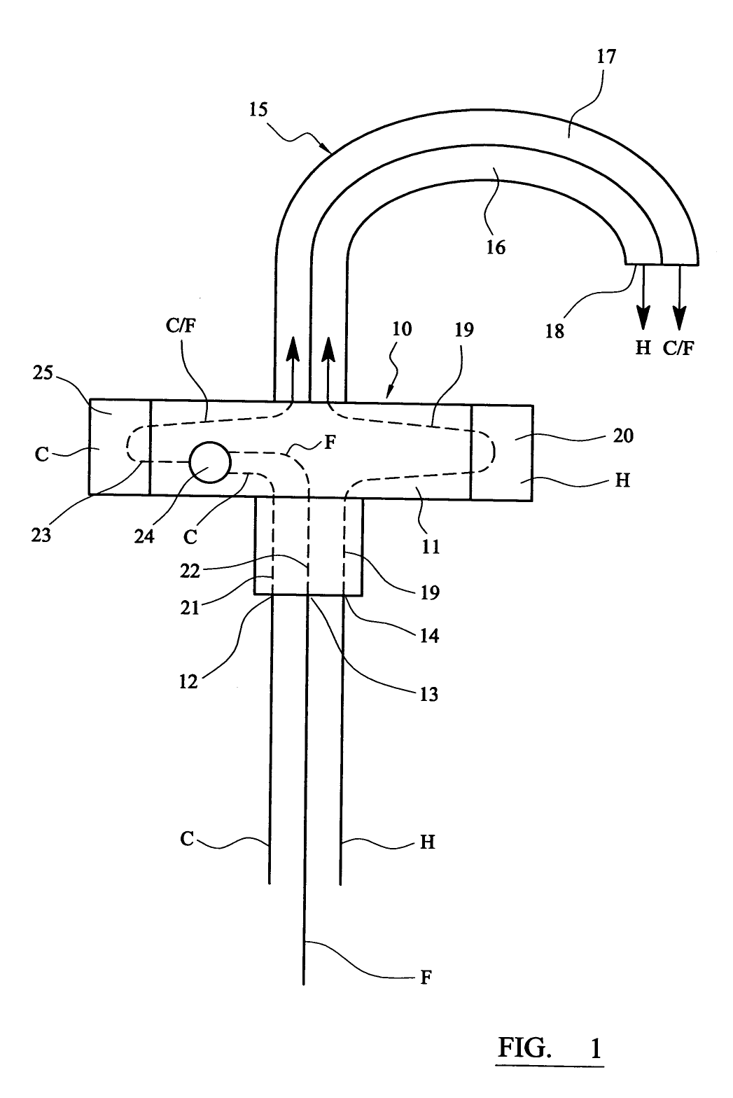

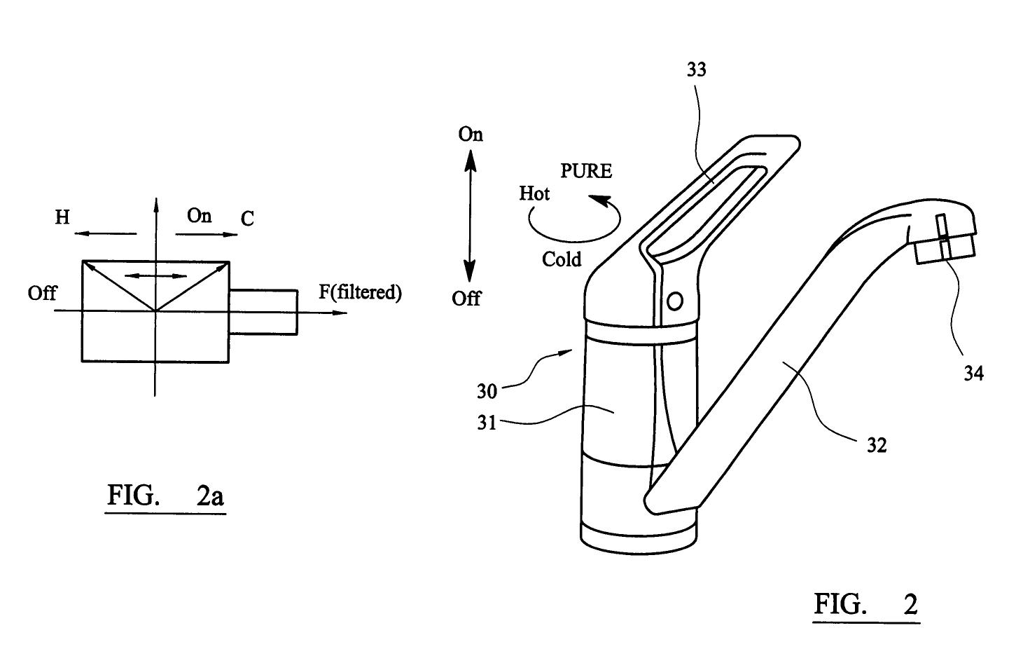

FIGS. 1 to 6 of the accompanying drawings are taken from publication number 2004/104306, and the construction and operation of which will now be described.

FIG. 1 is a schematic drawing of a general type of tap to which the invention may be applied;

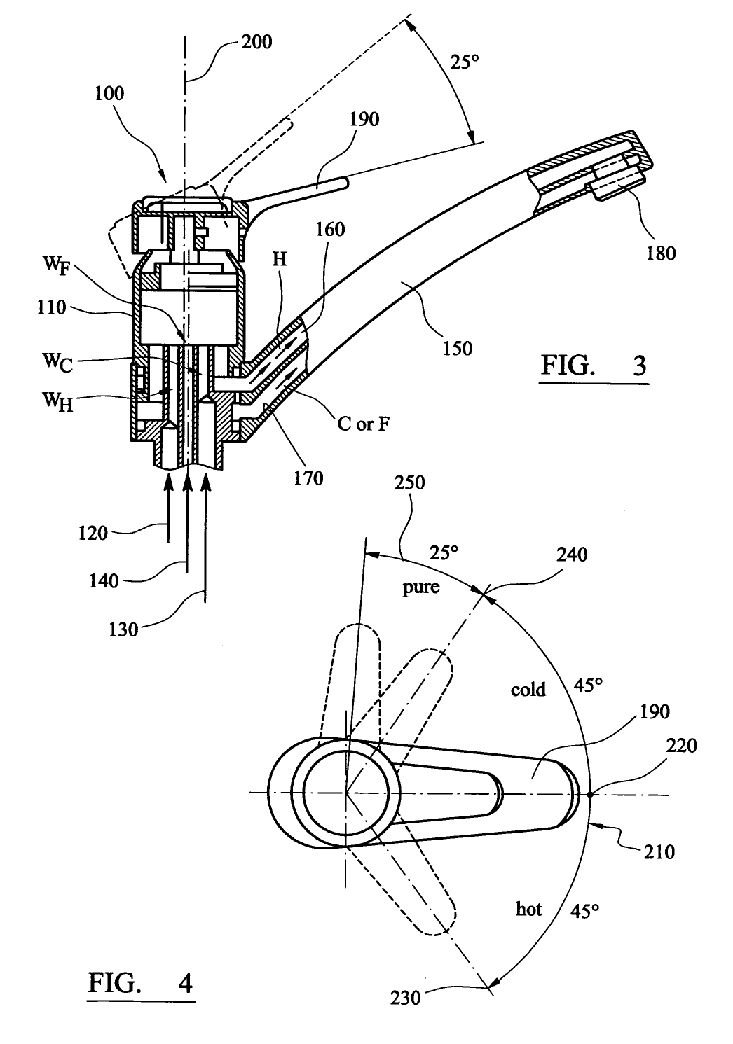

FIG. 2 is a perspective illustration of practical embodiment.

Referring first to FIG. 1 of the drawings, a water tap is designated generally by reference 10 and has a tap body 11, separate connections 12, 13, 14 on the tap body 11 for receiving, respectively, supplies of cold water C, filtered water F and hot water H. A common discharge spout 15 is mounted on the tap body 11, and valves operated by separate knobs, handles or levers are provided to control the supply of hot water H, cold water C and filtered water F from the tap body 11 to the discharge spout 15.

The discharge spout 15 is provided internally with two separate discharge passages only, namely first passage 16 which is dedicated to convey hot water only, and second discharge passage 17 which is dedicated to supply cold water or filtered water. As can be seen, the passages 16 and 17 lead to a common discharge outlet 18 of the spout 15.

The tap body 11 defines a route 19 for hot water only, under control of a hot water control valve 20, and route 19 communicates with the dedicated first discharge passage 16 of the discharge spout 15, and which can therefore discharge hot water only.

The tap body 11 also defines separate incoming routes 21 and 22 for each of the cold water C and the filtered water F. The tap body 11 also defines a common outgoing route 23 for one or the other only of cold water C and filtered water F, and such common outgoing route 23 communicates with the second discharge passage 17, which is dedicated to the common outgoing route 23.

A diverter valve 24 is mounted on the tap body 11 and is operative selectively to control the communication of the incoming route 21 for cold water C, or the incoming route 22 for filtered water F, with the common outgoing route 23. According to the operation of the diverter valve, cold water C or filtered water F can be discharged via the outlet 18 of the spout 15, via dedicated second discharge passage 17.

A dual purpose water control valve 25 is provided on the tap body 11, and is operative to control the flow along the common outgoing route 23.

Therefore, in the water tap 10 shown in the drawing, two discharge passages 16, 17 only are provided in the discharge spout 15, and the first passage 16 is dedicated to supply hot water only, whereas the second passage 17 selectively discharges cold water, or filtered water only, under the control of the dual purpose water control valve 25, and depending upon whether the diverter valve 24 communicates the incoming cold water route 21 or the incoming filtered water route 22 with the common outgoing route 23.

The dual purpose water control valve 25 can be quite simply a standard cold water control knob, button or handle, and the diverter valve 24 can be sourced economically by utilising existing technology available in bath taps, or similar.

The diverter valve 24 may be arranged to revert automatically to cold water routing to the common outgoing route (after operation to route filtered water only), and this reversion may be after a predetermined time period, or under spring or other return movement control.

Alternatively, the valves 24, 25 may be integrated in to a single valve assembly, having the dual function of (a) diverting and (b) routing cold water C or filtered water F via the common outgoing route.

Referring now to FIG. 2 of the drawings, this shows practical embodiment in which the features of the schematically illustrated embodiment of FIG. 1 are incorporated into a tap assembly having a common discharge spout for all three flows of water (hot water, cold water and filtered water), and also having a single operating lever.

The embodiment of FIG. 2 is designated generally by reference 30, and comprises a tap body 31 which communicates with three separate piped supplies (not shown) of hot water, cold water and filtered water, and which has a common discharge spout 32. A single operating lever 33 is provided, which can be pivoted upwardly to the “on” position, and downwardly to the “off” position.

Rotation of the lever 33 can be through three separate phases, as shown schematically. The rotation of the lever to the left effects operation of the internal valve assembly (not shown) to route hot water only through the tap body 31 and to be discharged via the outlet 34 of the common discharge spout 32. Rotation of the lever 33 in an anti-clockwise direction, as seen in plan view, brings it to a position in which it operates the internal valve assembly so that cold water only is routed through the tap body to be discharged via the outlet spout 34. Further rotation of the lever 33 brings it to a transition point, at which a “detent” is provided, and at such time the internal valve arrangement operates to divert the flow from cold water only to filtered water only, and which is routed through the discharge spout 32 and outlet 34.

This embodiment therefore provides a single lever movement tap, and may have internally a valve which has two or three purposes. The internal valve may comprise a cold/hot mixture arrangement, and progressive movement of the lever, in one direction or the other, alters the relative proportions of hot and cold water to suit requirements. The lever can take-up a position of hot water only, cold water only, or a mixture. Further movement through the cold range reaches the detent position, and thereafter flow is diverted to filtered water only.

Any suitable detent arrangement may be provided, including spring loaded latches etc, and preferably gives a defined “click” to indicate that the diverting point has been reached between cold water only and filtered water only.

The discharge spout 32 may be a single or dual flow spout i.e. with one or more internal passages.

The internal valve arrangement will take any suitable form, e.g. as disclosed above and shown schematically in FIG. 1. An alternative arrangement is shown in FIG. 2a.

FIG. 3 is a diagrammatic view in vertical section of an upper part of a water tap showing an upper part of a tap body, a single operating lever, and a discharge spout having two separate spout flow passages;

FIG. 4 is a plan view showing a range of movement of the operating lever;

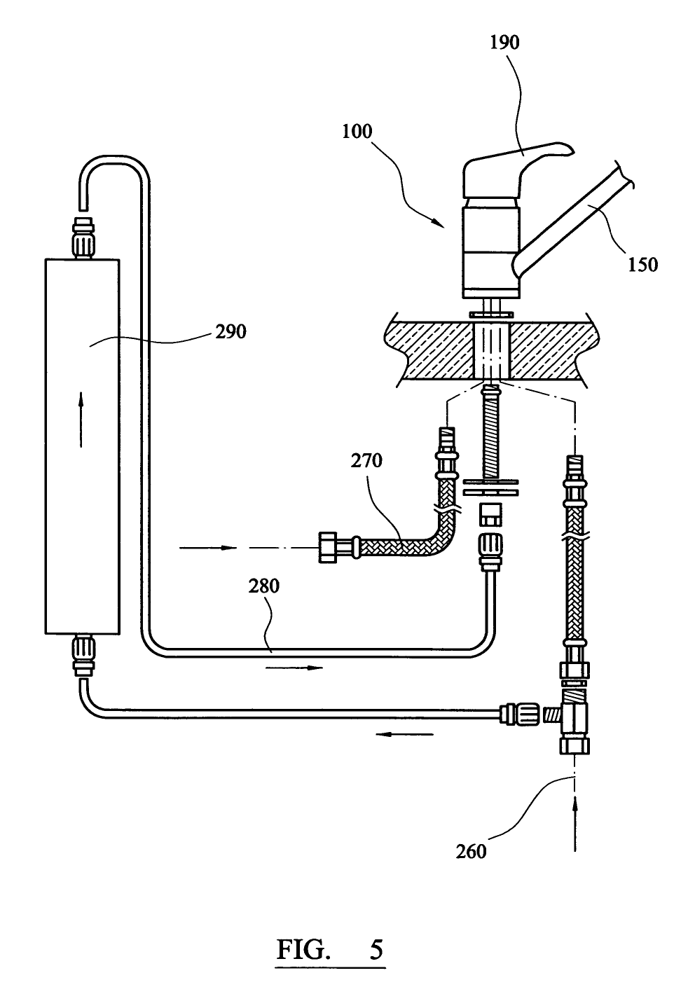

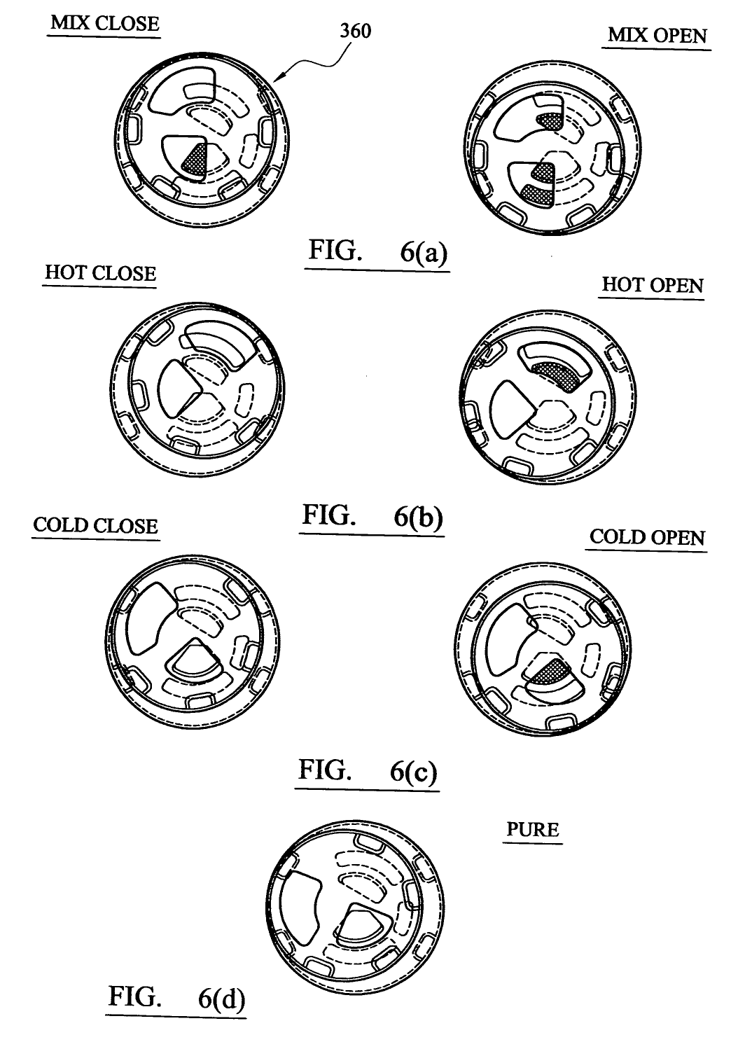

FIG. 5 is a diagrammatic view of a water installation incorporating the water tap;

FIGS. 6a to d are views showing different operating modes of an internal valve assembly within the tap body, and coupled with the operating lever to be adjusted between the different operating modes illustrated.

Referring now to FIGS. 3 to 6 of the drawings, a water tap is designated generally by reference 100 and comprises a tap body 110, of which the upper part is shown in FIG. 3, and having first, second and third inlets to the tap body for supplying respectively hot water, cold water and a further liquid to the interior of the tap body. The first, second and third inlets are designated by references 120, 130 and 140 respectively, and a discharge spout 150 is mounted on the tap body 110 and has two internal spout discharge passages 160 and 170, leading to a common discharge outlet 180 at or near its free end. Alternatively, there may be only a single discharge passage.

A single operating lever 190 is pivotally mounted on the upper part of the tap body 110, for adjustment movement about a substantially vertical axis 200 and along a predetermined first arc of movement 210, as shown in FIG. 4. The lever 190 is coupled with an internal valve assembly 260 (FIG. 6) within the tap body (described in more detail below) for selectively controlling the admission of liquids to the interior of the tap body via the first, second and third inlets 120, 130, 140, and also the discharge of selected liquid(s) from the tap body 110 to the discharge spout 150.

During adjustment movement of the lever 190 along the first arc of movement 210, the valve assembly 260 is adjusted to operate selectively to admit hot water and/or cold water to the tap body 110 via the respective first and second inlets 120, 130 according to the position of adjustment of the lever 190 along the arc of movement 210.

As shown in FIG. 4, the lever 190 has a mid position 220, in which the mixture proportions of hot and cold water will be approximately 50:50, whereas clockwise movement from the mid position to an end position 230 will progressively increase the proportion of hot water admitted via inlet 120 to the tap body 110, and progressively decrease the proportion of cold water admitted to the interior of the tap body 110 via inlet 130. Similarly, anti-clockwise movement from the mid position towards an opposite end position 240 will progressively increase the proportion of cold water and decrease the proportion of hot water. At each end position, there will be 100% flow of one of the liquids, and 0% admission of the other liquid.

Still referring to FIG. 4, the operating lever 190 also is movable along an arcuate extension 250 to the first arc of movement 210, in which the valve assembly 260 is adjusted to block admission of hot water and cold water via inlets 120, 130, and to allow admission only of further liquid via the third inlet 140.

Although not shown in detail, the interior of the tap body has dedicated waterways corresponding to each of the inlets 120, 130, 140, and under adjustment of the valve assembly, flow of hot water only, cold water only, or further liquid only along the respective waterways is blocked, or allowed, without any mixing of the liquids within the interior of the tap body.

The separate waterways lead to the inner end of discharge spout 150, and the routing of the waterways is such that the waterway Wh for hot water only leads to the spout discharge passage 160, whereas the waterways dedicated to cold water W_{c} and further liquid W_{f} (filtered or “pure” water) both lead to the spout discharge passage 170.

When the valve assembly is adjusted to end position 230 of lever 190, hot water only will be admitted to the tap body 110 via hot water inlet 120, and is then routed along a dedicated waterway Wₕ leading to spout passage 160, so that hot water H only is routed along the spout 150 and is discharged via outlet 180. When the lever 190 is adjusted to end position 240, cold water only is admitted to the tap body 110 via cold water inlet 130, and is then routed via waterway W_{c} for cold water which leads to entry end of spout passage 170, so that cold water C only flows along passage 170 to be discharged via outlet 180.

In the event that the lever takes-up a position intermediate the end positions 230 and 240, relative proportions of hot and cold water will be admitted to the tap body 110, and each proportion of hot water H and cold water C is then routed along its own dedicated waterway Wₕ and W_{c}, for independent passage along separate spout passages 160, 170, and then are discharged together via outlet 180, which may incorporate a mixer nozzle if required, if mixing of hot and cold is required.

When the operating lever 190 is rotated anti-clockwise beyond the end position 240 of the first arc of movement 210, the valve assembly is adjusted so as to block any admission of hot water via inlet 120 or cold water via inlet 130, and then allows admission of filtered water F via inlet 140, which communicates with dedicated internal waterway W_{f} which leads to the entry end of spout passage 170, so that filtered water F only flows along discharge spout 150, to be discharged via outlet 180.

The first arc of movement 210 subtends an angle of about 90° about the pivoting axis 200 of the lever 190, and the arcuate extension 250 extends beyond the cold water only end position 240 through an angle of approximately 25%. A biassed detent e.g. a spring-loaded ball or the like may be provided, to determine the end position 240, and which can only be overcome by deliberate force applied to the lever 190 to move the lever from the first arc of movement 210 and onto the arcuate extension 250.

The lever 190 is also adjustable about a substantially horizontal axis, as shown in FIG. 3, with a lower position of the lever 190 being an “off” position for all liquids supplied to the tap body, and the dashed outline showing an upper adjusted position of maximum volume of flow of liquid, of which the proportions will be dependent upon the position of the lever 190 along the path of movement shown in FIG. 2.

FIG. 5 shows water tap 100 incorporated in a water installation, preferably provided for a kitchen sink. Alternatively, the water tap 100 may be installed in/on a basin in a bathroom; or it may be mounted on a work surface. Cold water is supplied to the tap 100 via supply pipe 260, hot water via supply pipe 270, and filtered or purified water via supply pipe 280. A diverter arrangement (not described in detail) may divert cold water supply via a water filter cartridge 290, and the admission of cold water, hot water, and filtered water is then controlled by operation of the lever 190, as described above.

FIGS. 6a to d show different operating positions taken-up by the relatively slidable portions of an internal valve assembly 360, of which the movable portion is coupled with lever 190 to provide the required control of admission of: hot water only; cold water only; variable proportions of hot and cold water; and filtered water. A lower portion of the valve assembly is provided with inlets corresponding to inlets 120, 130, 140, and the upper movable portion of the valve assembly blocks or allows partial or total communication with the respective waterway Wₕ, W_{c} and W_{f}, according to the angle of adjustment of lever 190 about the axis 200. Upward adjustment of lever 190 about the horizontal axis increases the area of communication between each inlet and its respective waterway, to increase the volume of flow.

FIG. 6a shows in the left hand view adjustment of the valve assembly 360 to a position in which it is ready to receive supplies of hot and cold water via the inlets 120 and 130, but in which the tap 100 is effectively “switched-off”, by reason of the lever 190 being in the lower closed position. The right hand illustration of FIG. 6a shows the valve assembly adjusted to an “open” position in which both hot and cold water supplies are admitted to the tap body via the respective inlets, and then routed along the dedicated waterways without any mixing of the flows of hot and cold water internally of the tap body.

Similarly, FIG. 6b shows in the left hand view the valve assembly adjusted to a position to receive hot water supply only, but with the tap switched off FIG. 6b in the right hand view shows the valve assembly adjusted to receive hot water only.

FIG. 6c shows in the left hand view the positions of the valve assembly corresponding to being ready to receive cold water only, but with the tap switched off, whereas the right hand view shows the adjustment of the valve components to an open position for cold only.

Finally, FIG. 6d shows the valve assembly components adjusted to a position in which admission of cold water and hot water is blocked, and only filtered water is admitted via filtered water inlet 140 and then passes to dedicated waterway W_{f}, and leading to entry end of discharge passage 170 in spout 150.

### DESCRIPTION OF PREFERRED EMBODIMENT

The above description with reference to FIGS. 1 to 6 is intended to form background to the following description of a preferred embodiment of tap assembly according to the invention, with reference to FIGS. 7 to 15, in which:

FIG. 7 is a diagrammatic lay-out drawing of a single lever operating handle acting in conjunction with a side spray unit;

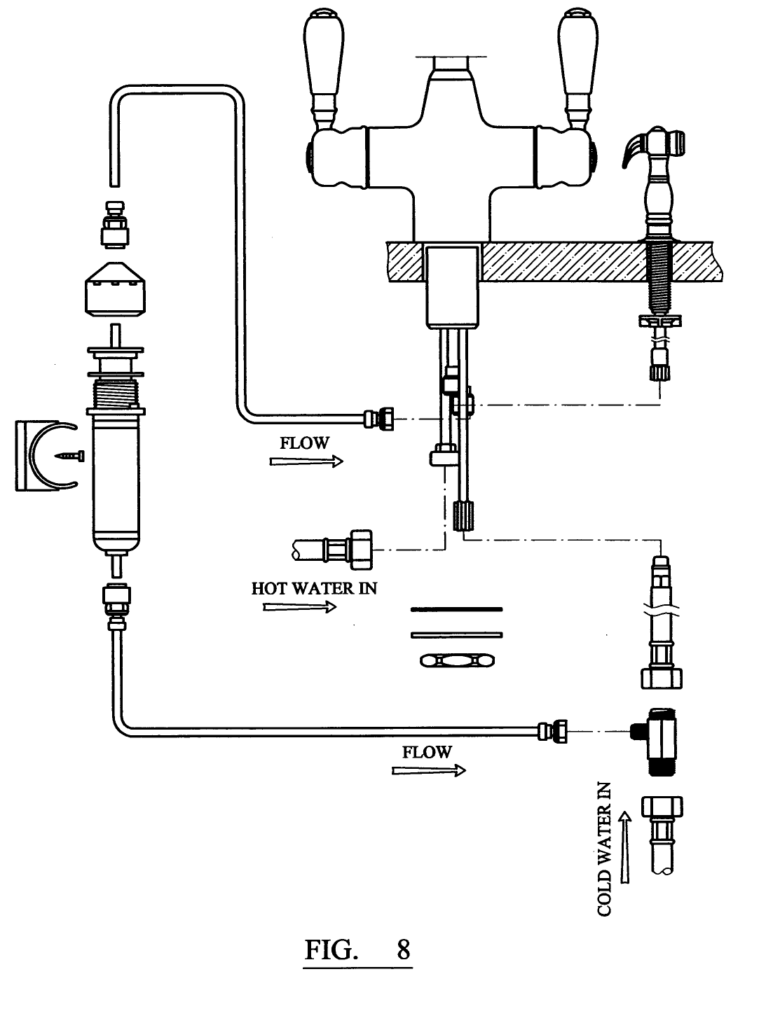

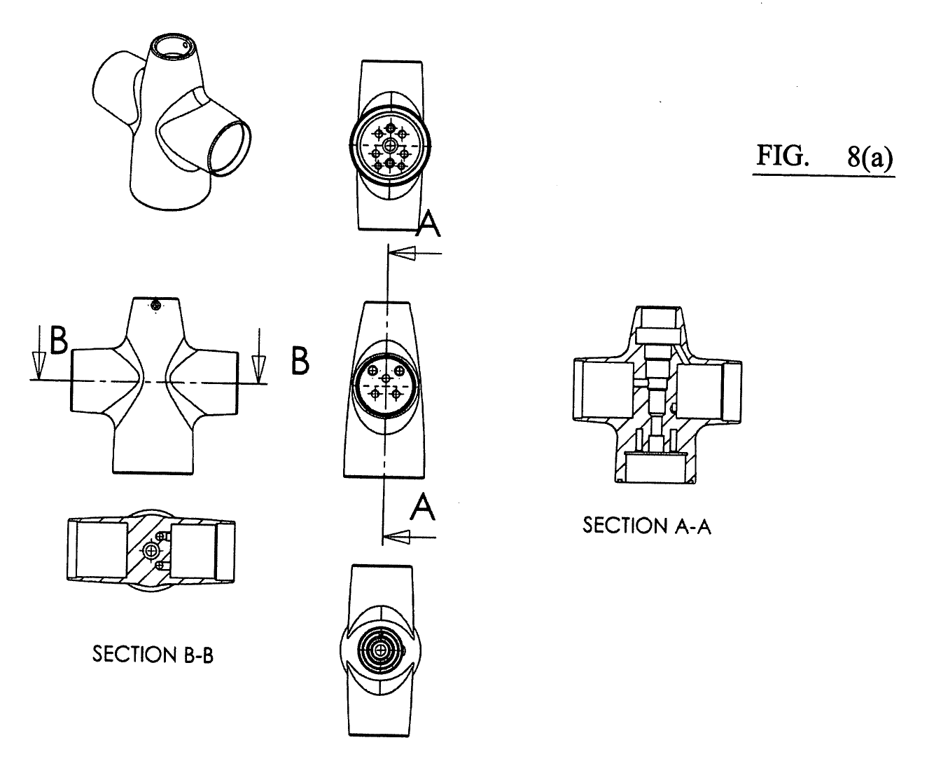

FIG. 8 is a view, similar to FIG. 7, showing a lay-out drawing of a monobloc two handle tap assembly and side spray unit;

FIG. 8a is a series of views of a detail of a two-handle cross-section monobloc tap fitting for use in a tap assembly according to the invention;

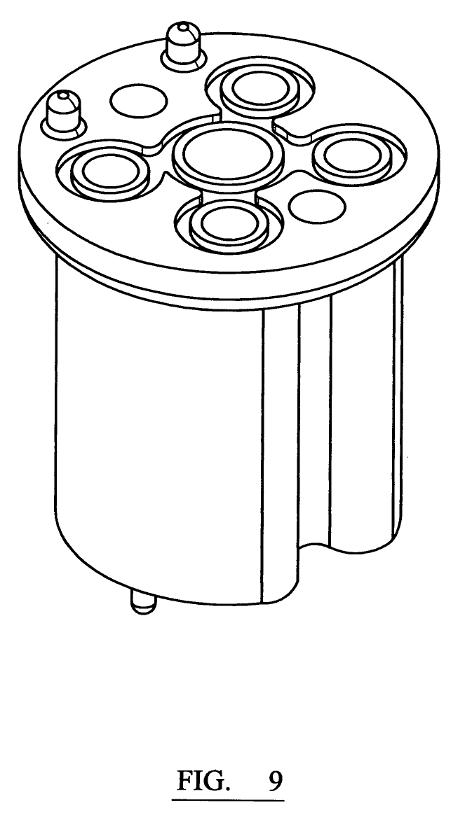

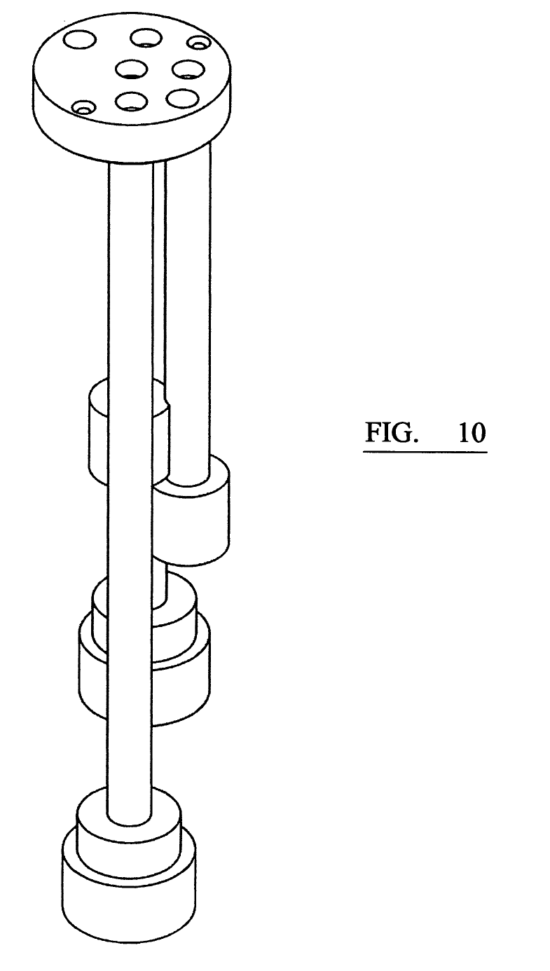

FIG. 9 shows a waterway chamber for use in a tap assembly according to the invention;

FIG. 10 illustrates waterway outlets for use in a tap assembly according to the invention;

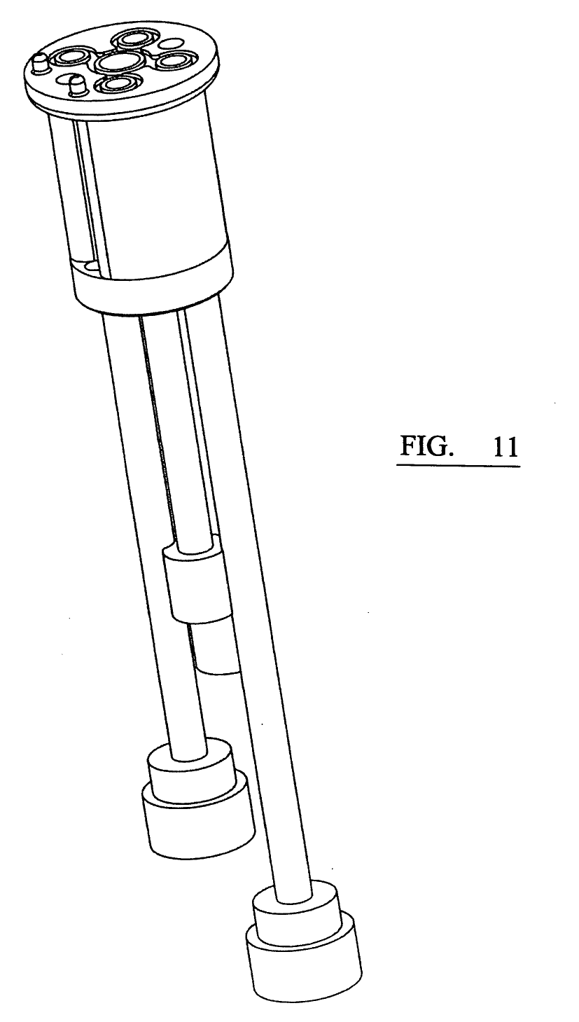

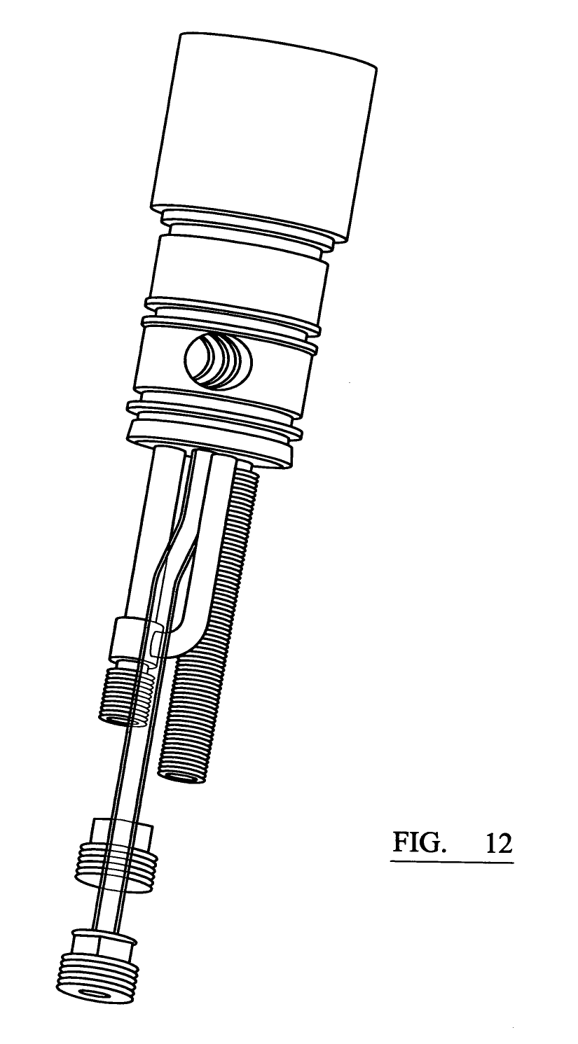

FIG. 11 shows a monobloc two handle chamber for use in a tap assembly according to the invention;

FIG. 12 shows a mixing chamber for use in a tap assembly according to the invention;

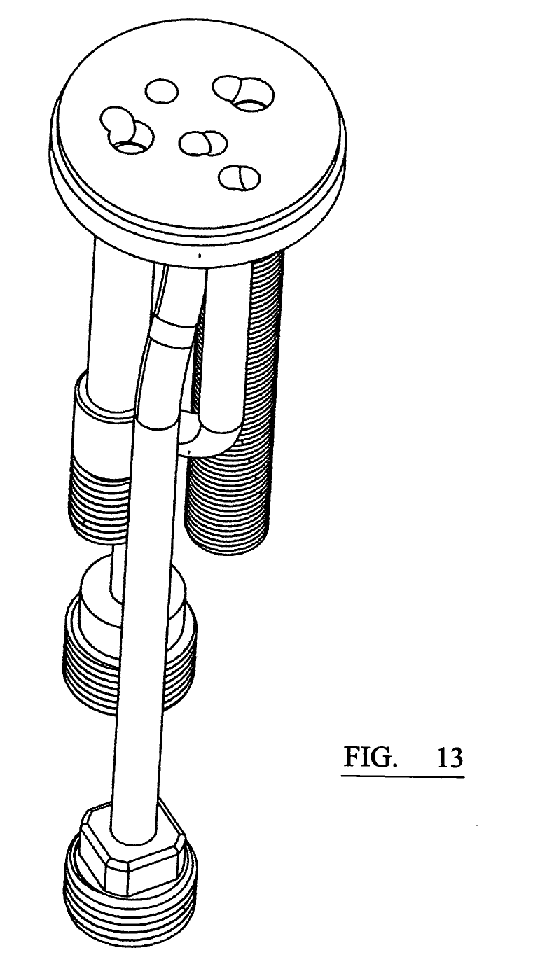

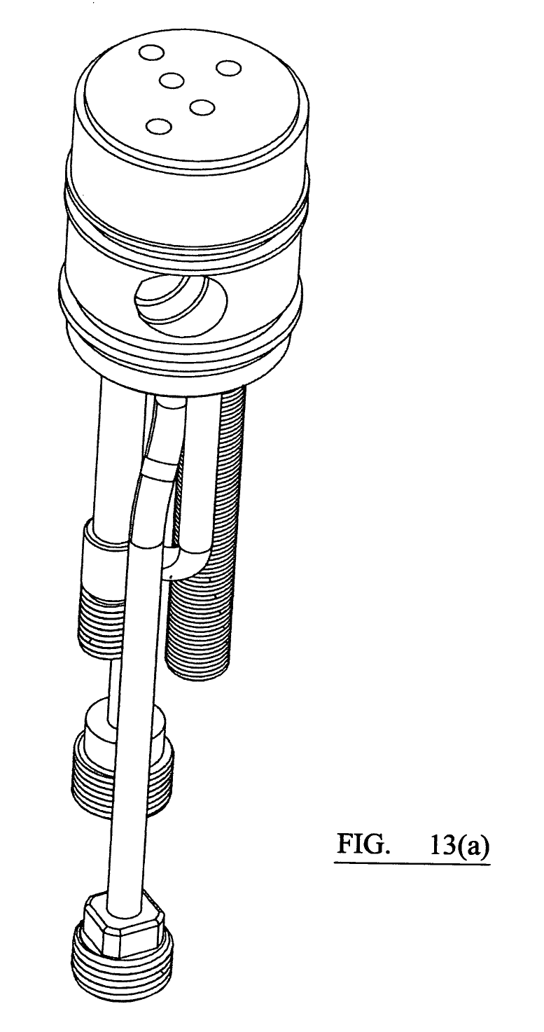

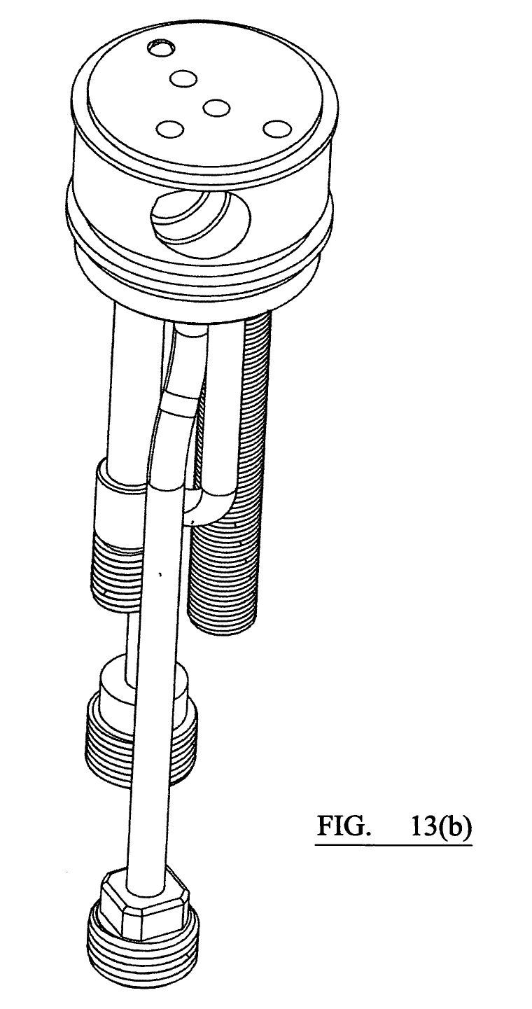

FIG. 13 shows a lower chamber of a single lever tap in a tap assembly according to the invention;

FIG. 13a shows a single lever mid chamber for use in a tap assembly according to the invention;

FIG. 13b shows a top chamber of a single lever tap assembly according to the invention;

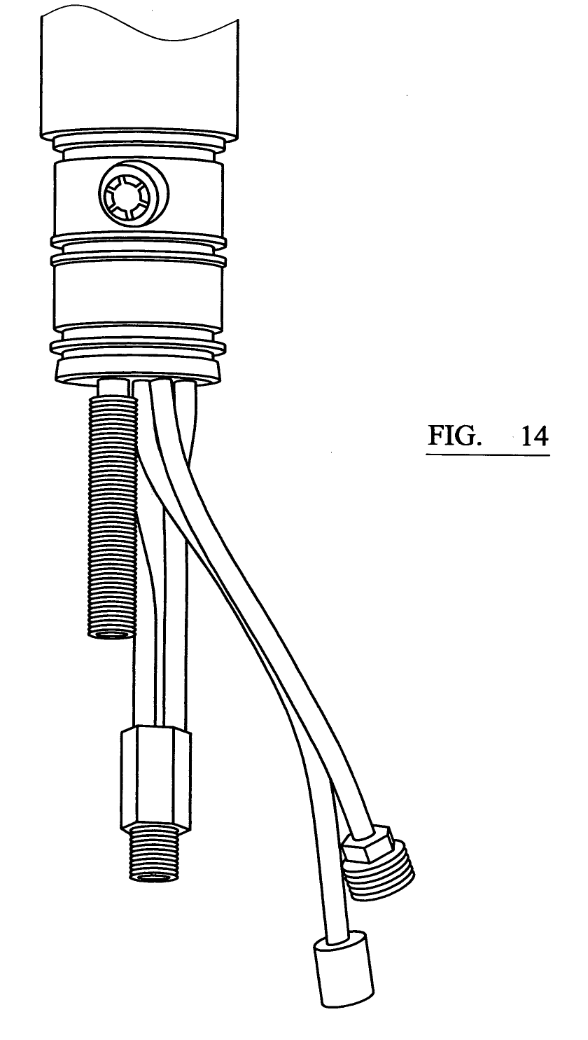

FIG. 14 shows a single lever handle lower chamber; and

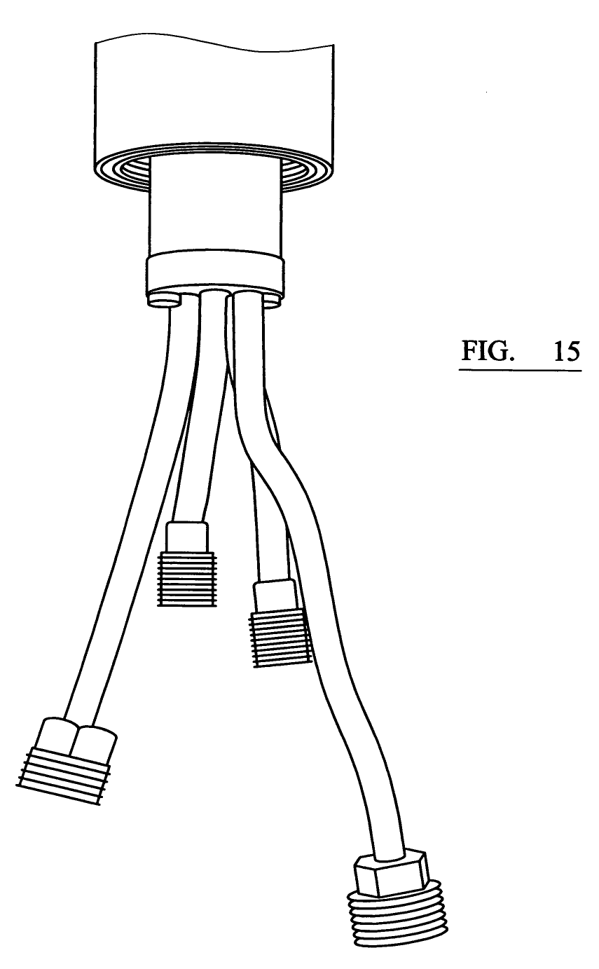

FIG. 15 shows a monobloc two handle assembly.

The embodiment which will be described with reference to FIGS. 7 to 15 comprises a water tap assembly, of the general type disclosed and described above with reference to FIGS. 1 to 6, in which a discharge spout has two separate discharge passages, one of which receives from the tap body hot water only, and the other of which can, selectively, receive cold water or filtered water. Alternatively, there may be a single discharge passage for hot water, cold water, mixed water and filtered water. The preferred embodiment now to be described provides a hand operated spray unit or “side spray” which is connected to the tap body, and which is capable of receiving hot water, cold water, or a mixture of hot and cold water, under suitable control provided on the tap body, to the spray unit, for the purposes of rinsing a sink unit with which the tap assembly is provided.

The tap body may be of the single lever type, or may be provided with dual control for hot and cold water (see FIGS. 7 or 8).

The preferred embodiment of the invention therefore provides, in a preferred form, an additional diverter arrangement, which is capable of being operated in order to route hot water, cold water or a mixture of hot and cold water, to a flexible supply pipe leading to a spray head of the spray unit. This is instead of such water being routed through the tap body to the common discharge spout, and with control over the supply of filtered water to the discharge spout, for passage along the common passageway dedicated to cold water or filtered water in the discharge spout.

The preferred embodiment therefore may be applied to a so-called “monobloc” mixer tap, with two handle control; alternatively, it may be applied to a monobloc single lever mixer (see FIG. 7 and 8). The discharge spout is able to discharge hot water/cold water/filtered water, whereas the separate routing of rinsing water via the side hand spray can provide hot/cold/mixed water for rinsing purposes.

Monobloc Two Handle Water Tap

In the monobloc two handle embodiment, provided with spray head facility, the following construction and operation is provided:

Hot water: quarter turn the valve to the dual flow spout, and to the side hand spray unit via a diverter vessel or arrangement external to the monobloc mixer body.

Cold water/filtered water: this passes to the dual flow spout in the manner described above with reference to FIGS. 1 to 6. The additional diverter vessel or arrangement external to the monobloc mixer body, serves to route cold water (and optionally filtered water) to the side hand spray unit.

The internal design for the cold/filtered water operation and flow is controlled by a uniquely designed flow control system, incorporating water flow holes, and is located below the main mixing chamber to control water flow to the specified discharge spout/spray control system (see FIGS. 9, 10, 11: option to include body cross section).

The side hand spray water control is via the uniquely designed diverter vessel, located outside of the main mixing chamber/mixer body which provides the water feed to the handset.

The water flow in the product is via:

Hot water: inlet pipe connection;

Cold water: inlet pipe connection;

Filtered water: inlet pipe connection;

Hot/cold/mixed/filtered: outlet connection to discharge spout;

Hot/cold/mixed water: outlet connection from remote diverter vessel to side hand spray.

Single Lever Water Tap Body

Hot water/cold water/filtered water this is routed to the discharge spout in the manner described above with reference to FIGS. 1 to 6. Rinsing water flow to the side hand spray is achieved by operation of the tap body and the additional diverter vessel or arrangement external to the monobloc mixer body.

The internal design for the cold/filter water operation and flow is controlled by a uniquely designed flow control system, incorporating water flow holes, and is located below the main mixing chamber to control water flow to the specified discharge spout/spray control system (see FIGS. 12, 13a, 13b with option to include body cross section).

The side hand spray water control is via the uniquely designed diverter vessel, located outside or externally of the mixer body providing the water feed to the handset (see FIG. 12).

The water flow in the product is via:

Hot water: inlet pipe connection;

Cold water: inlet pipe connection;

Filtered water: inlet pipe connection.

Hot/cold/mixed/filtered: outlet connection to discharge spout;

Hot/cold/mixed water: outlet connection from remote diverter vessel to side hand spray.

FIGS. 7 and 8 illustrate schematically a water tap assembly according to the invention, provided with additional routing, under suitable control, of rinsing water to a flexible supply pipe leading to a spray head.

FIG. 14 illustrates in more detail the additional diverter vessel or arrangement for routing rinsing water to the spray unit in the single lever water tap, as well as showing the incoming pipe connections for supplying hot water, cold water, and filtered water to the main tap body.

FIG. 12 illustrates adjustment and operation of the water tap assembly so as to discharge water via the common discharge spout. FIG. 13 illustrates adjustment of the water tap assembly so that rinsing water is routed to the spray unit.

FIG. 15 illustrates in more detail the additional diverter vessel or arrangement for routing rinsing water to the spray unit in the monobloc lever water tap, as well as showing the incoming pipe connections for supplying hot water, cold water and filtered water to the main tap body.

I claim:

1. A water tap assembly having a tap body, separate connections on the tap body for receiving supplies of hot water H, cold water C and filtered water F, a common discharge spout mounted on the tap body, and valve means for controlling the supply of hot water H, cold water C and filtered water F from the tap body to the discharge spout, in which:
the discharge spout is provided internally with two separate discharge passages only which lead to a common discharge outlet of the spout;
the tap body defines a route for hot water only which communicates with a dedicated first one of the two separate discharge passages in the discharge spout and which can therefore discharge hot water H only;
the tap body also defines a separate incoming route for each of the cold water C and the filtered water F, and a common outgoing route for one or the other only of cold water C and filtered water F and such common outgoing route communicating with a second of the two separate discharge passages and which is dedicated to said common outgoing route;
the valve means is operative selectively to divert the communication of the incoming route for cold water C, or the incoming route for filtered water F, with the common outgoing route depending upon whether cold water discharge or filtered water discharge is required, and to control the flow along said common outgoing route; and
a spray unit is coupled with the tap body, and the assembly is operative to route rinsing water to the spray unit.

2. A water tap assembly which comprises:
a tap body;
first, second and third inlets for supplying respectively hot water H, cold water C and a further liquid F to the interior of the tap body;
a discharge spout mounted on the tap body and having a discharge outlet at or near its free end;
an internal valve assembly in the tap body for selectively controlling the admission of liquids to the interior of the tap body via the first, second and third inlets and the discharge of selected liquid(s) from the tap body to the discharge spout; and,
a spray unit which is coupled with the tap body, and which is operative to discharge rinsing water routed to the spray unit via the tap assembly.

3. A water tap according to claim 2, in which the discharge spout has two dedicated passages, of which first passage serves to convey hot water H only, and second passage serves to convey cold water C only, or further liquid F only.

4. A tap assembly according to claim 1, in which an additional diverter vessel or arrangement is coupled with the tap body below a filter cartridge and the routing of water via the tap body to the common discharge spout and the assembly is operative to route rinsing water to the additional diverter vessel or arrangement, and then to a spray head provided at one end of a flexible pipe.

5. A tap assembly according to claim 1, in which the tap body is a monobloc body having a single lever control, or having separate controls for hot and cold water.
